(19) United States
(12) Patent Application Publication
(10) Pub. No.: US 2015/0153181 A1
(43) Pub. Date: Jun. 4, 2015

(54) SYSTEM AND METHOD FOR PROVIDING INDOOR NAVIGATION SERVICES

(71) Applicants: Andrew Gildfind, Brixton (GB); Simon Rowe, Berkshire (GB); John Hawkins, London (GB)

(72) Inventors: Andrew Gildfind, Brixton (GB); Simon Rowe, Berkshire (GB); John Hawkins, London (GB)

(73) Assignee: GOOGLE INC., Mountain View, CA (US)

(21) Appl. No.: 13/191,732

(22) Filed: Jul. 27, 2011

(51) Int. Cl. G01C 21/00; G01C 21/20; G06F 15/00; G01C 21/12

(52) U.S. Cl. CPC G01C 21/206

(57) ABSTRACT

Aspects of a system and method for providing indoor navigation services are described herein. Aspects of the disclosure provide an efficient method for identifying a location of a client device using accelerometers, gyroscopes, cameras, and/or position markers. Elements of the system relate to the determination of particular user locations by receiving location information pertaining to position markers from a remote server. A client device may identify a position marker using a camera, a Radio Frequency Identification (RFID) chip, or other method. An identifier describing the position marker may be sent to a remote server, and the remote server may provide a precise location to the client device.

### BACKGROUND

Portable electronic devices, such as smartphones, personal digital assistants (PDAs) and handheld location services devices are capable of performing a variety of functions, including location reporting, mapping, and route-finding operations.

These portable electronic devices often include an interface for receiving location information from global navigation satellite system (GNSS) satellites. These GNSS systems are capable of providing location information with a high degree of accuracy, such as within a few yards of resolution. However, these satellites require a direct line-of-sight to multiple satellites to achieve an accurate position fix. As such, these systems such as GPS are generally unsuitable for use in indoor navigation where such a line-of-sight is unavailable. Other methods of determining a user location that do not rely on line-of-sight, such as cellular tower navigation, wireless access point identification, etc. tend to be either inaccurate, unreliable, or both.

### BRIEF SUMMARY

A system and method for providing indoor navigation services are described. Aspects of the disclosure provide a computer-implemented method for providing indoor navigation services. The method includes identifying a position marker using a client device, wherein the position marker comprises a marker identifier that uniquely identifies the position marker within a set of marker data, and wherein the set of marker data comprises location information for a plurality of position markers, receiving a set of location information associated with the marker identifier, wherein the set of marker information comprises a first location of the position marker, and identifying a second location of the client device using the first location of the position marker received via the set of marker information. The position marker may be a quick response code or a radio frequency identifier tag identified by the client device. The set of marker information may further include a set of environmental constraints for an area around the position marker. The method may also include using the set of environmental constraints to improve the accuracy of the location client device. In some aspects, the method may include identifying a movement vector of the client device to track client device movement from the position marker using on-board sensors of the client device, and determining a new location of the client device using the movement vector and the first location. The on-board sensors may be at least one of an accelerometer, a step counter, and a gyroscope. The measured movement vector may be improved using data from at least one of a compass and a gyroscope. The method may include sending a location request to a remote server, wherein the location request comprises the marker identifier. The location request may include an estimated location of the client device such that the remote server may update the marker information with the estimated location of the client device. In some aspects, the method includes extracting the set of marker information from data embedded within the position marker. The method may also include determining whether the position marker is a canonical position marker from the set of marker information, and, if the position marker is not a canonical position marker, using a secondary method of identifying the second location of the client device in response to the determination that the position marker is not a canonical position marker. The secondary method may be at least one of cellular tower triangulation, global positioning system identification, or wireless access point identification.

Aspects of the disclosure also provide a system for providing indoor navigation services. The system includes at least one processor operable to receive a marker identifier associated with a particular position marker, from a client device, to access a set of marker information identified by the marker identifier, from a position marker database, and to transmit the set of position marker information to the client device for use in identifying the location of the client device, and a memory, coupled to the processor, for storing the position marker database. The processor may be further configured to receive an estimated location from the client device along with the position marker identifier, and to update the set of position marker information with the estimated location to improve the accuracy of the location of the particular position marker. In some aspects, the processor may be further configured to establish a new entry in the position marker database for a new position marker based on a location of the new position marker as identified by the client device. The processor may be configured to identify the particular position marker as canonical when the location of the particular position marker is established with greater than a particular accuracy threshold. The particular accuracy threshold may be a minimum number of measurements received.

Aspects of the disclosure may also provide a computer-implemented method for providing indoor navigation services. The method may include receiving a location request comprising a marker identifier, accessing, using a processor, a set of marker data that comprises a position of one or more position markers, wherein each of the position markers is indexed within the set of marker data by a unique identifier, matching the marker identifier with the unique identifier to determine the location of a position marker associated with the marker identifier, and identifying the location of a client device using the determined location of the position marker. The method may further include receiving a client device location with the location request, and updating the set of marker data using the client device location. In some aspects, the method may include including the client device location in a portion of the set of marker data describing the position marker associated with the marker identifier, and using the client device location to improve the accuracy of the location of the position marker associated with the marker identifier. The method may include receiving an uninitialized marker identifier and an initial location estimate, including the uninitialized marker identifier in the set of marker data as a new position marker, and associating the initial location estimate with the new position maker. The method may further include receiving an additional location estimate for the new position marker, including the additional location estimate in the set of marker data, and determining a location of the new position marker using the additional location estimate and the initial location estimate. In some aspects, the method further includes determining an estimated accuracy of the location of the new position marker based on at least one of a number of location estimates received for the new position maker and the location of a plurality of location estimates received for the new position marker, and identifying the new position marker as a canonical position marker when the estimated accuracy exceeds a particular threshold value.

Aspects of the disclosure also provide a non-transitory computer readable storage medium containing instructions that, when executed by a processor, perform a method. The method includes identifying a position marker using a client device, wherein the position marker comprises an identifier that uniquely identifies the position marker within a set of marker data, receiving a set of marker information associated with the identifier, wherein the set of marker information comprises a first location of the position marker, and identifying a second location of the client device using the first location of the position marker as received via the set of marker information. The position marker may be a quick response code or a radio frequency identifier tag identified by the client device. The set of marker information may include a set of environmental constraints for an area around the position marker. The method executed by the processor may include using the set of environmental constraints to improve the accuracy of the location client device. In some aspects, the method executed by the processor includes identifying a movement vector of the client device to track client device movement from the position marker using at least one accelerometer to measure a velocity and a direction of travel, and determining a new location of the client device using the movement vector and the first location.

### BRIEF DESCRIPTION OF THE DRAWINGS

FIG. 1 is a system diagram depicting an example of a system for providing indoor navigation services in accordance with aspects of the disclosure.

FIG. 2 is floor diagram depicting operation of an example of a system for providing indoor navigation in accordance with aspects of the disclosure.

FIG. 3 is a flow diagram depicting an example of a method for identifying an indoor position using a client device in accordance with aspects of the disclosure.

FIG. 4 is a flow diagram depicting an example method for calibrating a positioning module of a client device in accordance with aspects of the disclosure.

FIG. 5 is a flow diagram depicting an example of a method for providing marker information in accordance with aspects of the disclosure.

FIG. 6 is a flow diagram depicting an example of a method for employing an adaptive positioning system in accordance with aspects of the disclosure.

FIG. 7 is a flow diagram depicting an example of a method for initializing a position marker using a precise position fix in accordance with aspects of the disclosure.

### DETAILED DESCRIPTION

Aspects of a system and method for providing indoor navigation services are described herein. Aspects of the disclosure provide an efficient method for identifying a location of a client device using accelerometers, gyroscopes, cameras, compasses, and/or position markers. Elements of the system relate to the determination of particular user locations by receiving location information pertaining to position markers from a remote server. A client device may identify a position marker using a camera, a Radio Frequency Identification (RFID) circuit, or via other methods. An identifier describing the position marker may be sent to a remote server, and the remote server may provide a precise location to the client device.

Elements of the client device may make use of compasses, accelerometers, step counters, and/or gyroscopes to identify movement from a calibrated position. The movement may be summed to estimate a new position of the client device. The client device may also make use of constraints received from the remote server to more accurately estimate the new position of the client device.

In some aspects, estimated positions may be provided to the remote server in conjunction with a newly identified position marker to calibrate the position of the newly identified position marker within a marker database stored on the remote server. The client device may also provide the remote server with location history data, which may be used by the remote server to establish constraints that are supplied to other client devices for use in location estimation operations.

For situations in which the systems discussed here collect information about users, the users may be provided with an opportunity to opt in/out of programs or features that may collect personal information (e.g., information about a user's location, a user's preferences, or a user's location history as used to establish constraints). In addition, certain data may be anonymized in one or more ways before it is stored or used, so that personally identifiable information is removed. For example, a user's identity and location may be anonymized so that the personally identifiable information cannot be determined or associated for the user and so that identified user preferences or user interactions are generalized (for example, generalized based on user demographics) rather than associated with a particular user. Aspects that rely on a user location may identify the location in a general manner. For example, the system may provide information in a binary manner (e.g., a user is nearby, or they are not nearby) rather than specifically identifying a proximity or location.

Aspects of the system and methods may utilize position markers to perform indoor navigation services. These position markers may be physical objects, images (e.g., posters, pictures, paintings, stickers, and quick response codes), devices, RFID tags, or any other feature perceivable by a mobile device sensor. Each position marker is associated with an identifier. The identifier is composed of data that may be used to look up data associated with the position marker. For example, a set of three position markers might be associated with the identifiers “1,” “2,” and “3.” A client device may use the identifier to access data associated with the position marker. For example, the client device may transmit a data request for information about marker “2.” In response, a remote server may provide the client device with the latitude and longitude location of marker “2.”

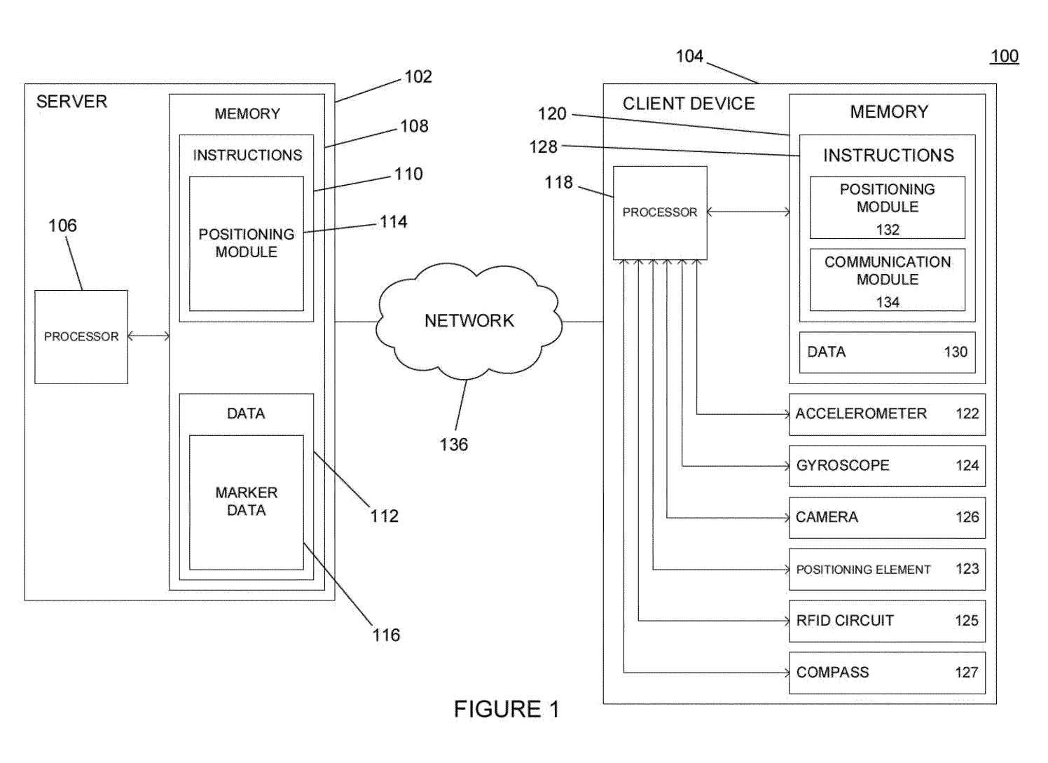

FIG. 1 is a system diagram depicting an example of a system 100 for providing indoor navigation services in accordance with aspects of the disclosure. As shown in FIG. 1, an example of an indoor navigation system 100 includes a remote server 102 coupled to a client device 104 via a network 136.

The remote server 102 may include a processor 106, memory 108 and other components typically present in general purpose computers. The processor 106 may be any processor capable of execution of computer code. Alternatively, the processor may be a dedicated controller such as an application-specific integrated circuit (“ASIC”) or other processing device.

Memory 108 may store information that is accessible by the processor 106, including instructions 110 that may be executed by the processor 106, and data 112. The memory 108 may be of any type of memory operative to store information accessible by the processor 106, including a computer-readable medium, or other medium that stores data that may be read with the aid of an electronic device, such as a hard-drive, memory card, read-only memory (“ROM”), random access memory (“RAM”), digital versatile disc (“DVD”) or other optical disks, as well as other write-capable and read-only memories. The system and method may include different combinations of the foregoing, whereby different portions of the instructions and data are stored on different types of media.

The instructions 110 may be any set of instructions to be executed directly (such as machine code) or indirectly (such as scripts) by the processor 106. For example, the instructions 110 may be stored as computer code on the computer-readable medium. In that regard, the terms “instructions” and “programs” may be used interchangeably herein. The instructions 110 may be stored in object code format for direct processing by the processor 106, or in any other computer language including scripts or collections of independent source code modules that are interpreted on demand or compiled in advance.

The instructions 110 may comprise a positioning module 114. The positioning module 114 is operable to send and receive positioning information to a client device, such as the client device 104. The positioning module 114 may receive an identifier from the client (e.g., “2,” as described above) for a particular location marker, and provide information associated with the marker to the client device 104 (e.g., the latitude and longitude of marker 2). For example, the positioning module 114 may provide the client device 104 with a precise geographical location associated with the position marker by looking up information associated with the position marker from a set of marker data 116.

The positioning module 114 may also receive an estimated location with a marker identifier, and store the estimated location in the marker data 116 to accurately determine the position of the marker associated with the marker identifier. For example, the positioning module 114 may use the estimated location to update the position or the position marker associated with the marker identifier.

The positioning module 114 may also receive location history data from the client device 104, which may be used to establish various location constraints proximate to a marker. The location constraints may then be provided to other client devices to increase accuracy in location estimation. For example, a location history may indicate that users typically only change their position elevation in a small area proximate to a position marker, which may be indicative of an elevator or stairwell, or that users only enter a particular part of a building via a particular location, which may be indicative of the presence a door at the particular location.

While the positioning module 114 may be a distinct module, aspects may alternatively provide similar functionality and other functionalities combined in a single module, or multiple modules. Aspects of the instructions 110 may be implemented as software executed on the processor 106 or by various hardware interfaces, such as ASICs, field-programmable gate arrays (“FPGAs”), or other processing devices.

Data 112 may be retrieved, stored or modified by the processor 106 in accordance with the instructions 110. For instance, although the architecture is not limited by any particular data structure, the data may be stored in computer registers, in a relational database as a table having a plurality of different fields and records, Extensible Markup Language (“XML”) documents or flat files. The data may also be formatted in any computer readable format such as, but not limited to, binary values or Unicode. By further way of example only, image data may be stored as bitmaps comprised of grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data may comprise any information sufficient to identify the relevant information, such as numbers, descriptive text, proprietary codes, references to data stored in other areas of the same memory or different memories (including other network locations) or information that is used by a function to calculate the relevant data.

Portions of the data 112 may comprise marker data 116. The marker data 116 may be stored in a database indexed by identifiers, each identifier associated with a particular position marker. For example, position markers may take the form of RFID devices, quick response (QR) codes, or any other device, image, or indicator perceptible to the client device 104 that indicates a particular marker identifier. The client device 104 may derive the marker identifier from the position marker, and send a location request to the remote server 102 with the identifier. The remote server 102 may access the data within the marker data 116 to provide the client device 104 with location information.

The marker data 116 includes location information associated with each marker identifier. The location information may establish a particular position marker as “canonical.” A canonical marker has been verified as located at a particular position with a specified threshold level of accuracy. For example, a device incorporating one or more high precision accelerometers and/or one or more high precision global positioning system (GPS) receivers may have been used to verify the position of a canonical marker. Alternately, a marker that has been independently verified by a threshold number of client devices (e.g., 5 devices, 10 devices, 100 devices, etc.) within a threshold area (e.g., within a six inch radius of a particular latitude and longitude, within a 3 foot radius of a particular intersection, within 100 yards of a particular building, etc.), may be established as a canonical marker. Canonical markers may be identified as providing a more accurate or trustworthy position fix than non-canonical markers. Whether a particular marker is canonical may alter whether the client device attempts to verify a location via a secondary method.

Other exemplary methods for determining an approximate location may include identifying a location based on nearby cellular towers or nearby wireless access points. While such techniques are generally less accurate than a multiple GNSS satellite position fix, the approximate location may be used to simplify aspects of the location identification operation. For example, if the client device 104 can be identified within a one mile radius, then the system may filter the position markers and location constraints to include only those markers within the one mile radius. The client device 104 may also determine an approximate location based on a most recent known GPS fix, which may identify the previous location before the user lost line-of-sight with the GNSS satellites (e.g., went indoors). Aspects may also allow the user to manually specify a current location, such as “within Grand Central Station” or the like.

The marker data 116 may also be grouped into general location categories. For example, position markers may be identified as being located in a particular office complex, shopping mall, city block, neighborhood, city, county, state, etc. The client device 104 may provide a general position fix, for example, using wireless network data, to optimize the data retrieval process. Categorizing position markers in this manner may also increase the number of available identifiers by providing a secondary method of indexing.

The marker data 116 may also include constraints associated with the local area of each position marker as described above. These constraints may be identified from submitted location histories and then provided to client devices to assist in position estimations. For example, if the constraints indicate that there is a wall with a door in the vicinity of a position marker, then the client device can eliminate possible positions that would result in the client device having traveled through the wall in a location other than where the door is located.

The client device 104 is operable to send a location request to the remote server 102. The location request may comprise a marker identifier, an estimated location, and/or a recent location history. The remote server 102 receives the location request and sends, to the client device, information associated with the marker identified by the position identifier.

Although FIG. 1 functionally illustrates the processor 106 and memory 108 as being within the same block, the processor 108 and memory 110 may actually comprise multiple processors and memories that may or may not be stored within the same physical housing. Accordingly, references to a processor, computer or memory will be understood to include references to a collection of processors, computers or memories that may or may not operate in parallel.

Although certain advantages are obtained when information is transmitted or received as noted above, other aspects of the system and method are not limited to any particular manner of transmission of information. For example, in some aspects, information may be sent via a medium such as an optical disk or portable drive. In other aspects, the information may be transmitted in a non-electronic format and manually entered into the system.

The client device 104 may comprise a mobile phone, a personal computer, a PDA, a tablet PC, a netbook, etc. In this regard, the client device 104 may have a display comprising a monitor having a screen, a projector, a television, a computer printer or any other device that is operable to display information. The client device 104 may accept user input via other components such as a mouse. Indeed, devices in accordance with the systems and methods described herein may comprise any device operative to process instructions and transmit data to and from humans and other computers including general purpose computers, network computers lacking local storage capability, etc.

The client device 104 may be configured similarly to the remote server 102, with a processor 118 and memory 120. As described with respect to the remote server 102, the memory 120 may comprise a set of instructions 128 and a set of data 130. The processor 118 executes the instructions 128 to control operation of the client device 104. In some aspects, the client device 104 may be a mobile phone operative to wirelessly exchange data with a server over a network such as the Internet. The instructions 128 may include a positioning module 132 and a communication module 134. The positioning module 132 provides an interface for generation of a location request. The positioning module 132 may also display the user location along with a map and/or routing information. The positioning module 132 may identify a user location, allow the user to input a destination, and display a route from the user location to the destination. The positioning module 132 may determine the route, or the positioning module 132 may interface with the remote server 102 via the communication module 134, to send location and/or destination data and receive a route and/or location for display. The positioning module 132 may also interface with other elements of the device, such as an accelerometer 122, a positioning element 123, a gyroscope 124, a RFID circuit 125, a camera 126, and/or a compass 127 to identify a position of the client device 104, such as by identifying a position marker or client device movement.

The client device 104 may have all of the components normally used in connection with a wireless mobile device such as a central processing unit (CPU), memory (e.g., RAM and ROM) storing data and instructions, an electronic display (e.g., a liquid crystal display (“LCD”) screen or touch-screen), user input (e.g., a keyboard, touch-screen or microphone), camera, a speaker, a network interface component, and all of the components used for connecting these elements to one another. Some or all of these components may all be internally stored within the same housing, e.g. a housing defined by a plastic shell and LCD screen.

The client device 104 may also include a positioning element 123, to determine the location of the device. For example, client device 104 may include a Global Positioning System (“GPS”) receiver that may determine the latitude, longitude and altitude of the client device 104 when in line-of-sight of one or more GNSS satellites. The positioning element 123 may also comprise software and/or hardware operative to determine the position of the device based on other signals received at the client device 104. As specific, non-limiting examples, these other signals may comprise signals received from one or more cell phone towers where the client device 104 includes a cell phone, signals received from local wireless access points, etc.

In some aspects, the client device 104 may also include an accelerometer 122, a gyroscope 124, and/or a compass 127 to determine the orientation and movement of the device. By way of example only, the client device 104 may determine its pitch, yaw, roll, and/or movement, (or changes thereto) relative to the direction of gravity or a plane perpendicular thereto.

The remote server 102 may be at one node of a network 136 and be operative to directly and indirectly communicate with other nodes of the network. For example, the remote server 102 may comprise a web server that is operative to communicate with the client device 104 via the network 136 such that the remote server 102 uses the network 136 to transmit and display information to a user via the client device 104. The remote server 102 may also comprise a plurality of computers that exchange information with different nodes of a network for the purpose of receiving, processing and transmitting data to the client devices; in this instance, the client device 104 may be at a different node of the network than any of the computers comprising the remote server 102.

The network 136, and the intervening nodes between the remote server 102 and the client device 104, may comprise various configurations and use various protocols including the Internet, World Wide Web, intranets, virtual private networks, local Ethernet networks, private networks using communication protocols proprietary to one or more companies, cellular and wireless networks (e.g., Wi-Fi), instant messaging, hypertext transfer protocol (“HTTP”) and simple mail transfer protocol (“SMTP”), and various combinations of the foregoing. Although only a single client device is depicted in FIG. 1, it should be appreciated that a typical system may include a large number of connected computers.

Although some functions are indicated as taking place on the remote server 102 and other functions are indicated as taking place on the client device 104, various aspects may be implemented by a single computer having a single processor. In accordance with one aspect of the system and method, operations performed on the client 104 and/or cameras 106 may be implemented on the remote server 102, and vice-versa.

The system and method may process locations expressed in different ways, such as latitude/longitude positions, street addresses, street intersections, an x-y coordinate with respect to the edges of a map (such as a pixel position when a user clicks on a map), names of buildings and landmarks, and other information in other reference systems that is operative to identify a geographic locations (e.g., lot and block numbers on survey maps). Moreover, a location may define a range of the foregoing.

The system and method may further translate locations from one reference system to another. For example, the remote server 102 may access a geocoder to convert a location identified in accordance with one reference system (e.g., a street address such as “1600 Amphitheatre Parkway, Mountain View, Calif.”) into a location identified in accordance with another reference system (e.g., a latitude/longitude coordinate such as (37.423021°, −122.083939)). In that regard, it will be understood that exchanging or processing locations expressed in one reference system, such as street addresses, may also be received or processed in other references systems as well.

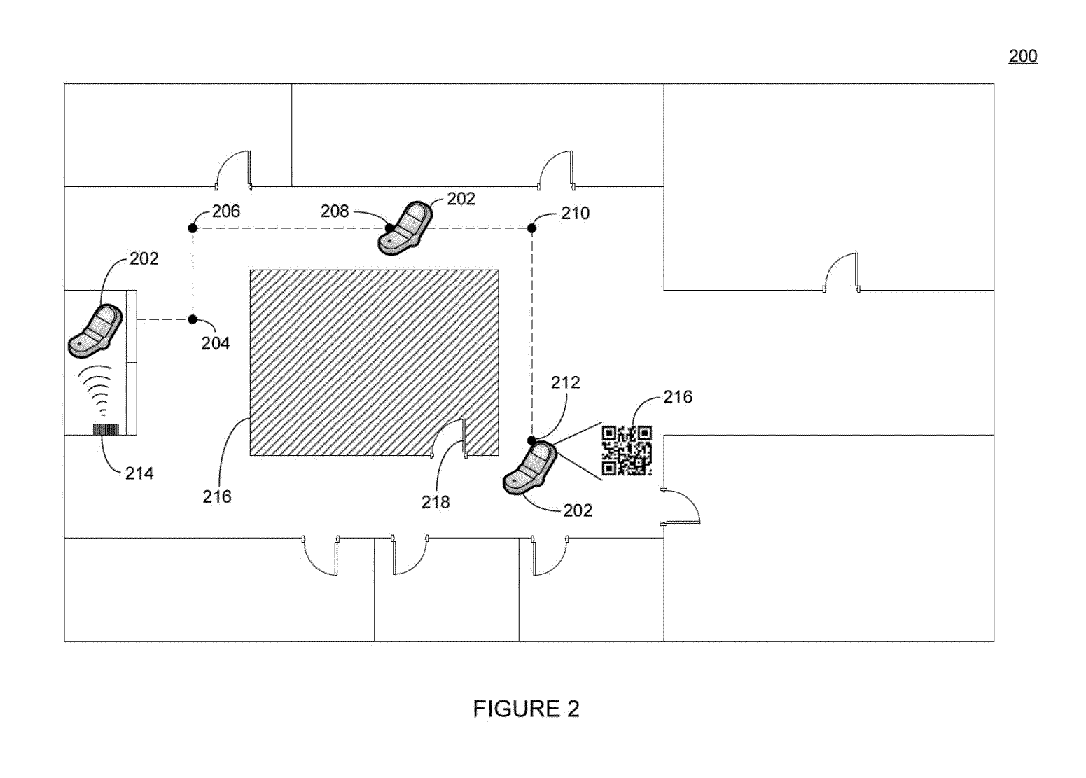

FIG. 2 is floor diagram 200 depicting exemplary operation of a system for providing indoor navigation in accordance with aspects of the disclosure. The floor diagram 200 represents the interior of a building, such as an office building or shopping mall. Such interiors typically don't allow for the line-of-sight needed to receive accurate positions via satellite. Aspects of the system and method provide accurate position estimates for a client device despite this limitation. Various position markers may be used in conjunction with accelerometers, gyroscopes, compasses, and device position constraints to provide an accurate indoor device location.

A client device 202 may enter a building via a security door containing a RFID security system 214. The RFID security system 214 may interface with a circuit on the client device 202 to identify the user of the client device 202. Aspects of the system and method 214 may utilize the fact that RFID communications require short range communication to identify the location of the client device 202. For example, the RFID security system 214 may broadcast a signal indicate the position of the security system 214, or it may broadcast a unique identifier that the client device 202 may transmit to a remote server, such as the remote server 102. The remote server 102 may then respond to the client device with the location of the security system 214. In some aspects, the remote server 102 may be adaptively programmed with the location of position markers, such as the security system 214, by client devices reporting their location along with the unique marker identifier encoded within the position marker.

In some aspects, the client device 202 may identify a location using a GPS receiver just prior to entering the interior of the building. This GPS location may then be used with accelerometer, gyroscope, compasses, and position marker information to provide an estimated interior location.

As the client device 202 travels throughout the interior, via positions 204, 206, 208, 210, and 212, updated positions may be obtained by tracking the movement of the client device using, for example, an accelerometer, a gyroscope, a step-counter and/or a compass. The accelerometer, gyroscope, and/or compass identify the movements of the client device 202 by attempting to measure the velocity and acceleration of the client device 202 as it travels. For example, the client device 202 may calibrate the device position at the RFID security system 214 when the user enters the building. As the user passes to point 204, the accelerometer may measure the client device 202 has traveled 6 feet forward. As the user passes from point 204 to point 206, the gyroscope may register a 90 degree left turn, followed by forward travel for another 6 feet. The various distance and velocity vectors identified as the user passes through the points are summed to the originally calibrated position to estimate a current location.

As small errors may accumulate as the number of added vectors increases, aspects of the system and method utilize techniques to increase the accuracy of the estimated location of the client device. For example, the room 216 has an entry at door 218. Client devices, such as the client device 202, may opt-in to provide location history information to the remote server. The location history information might indicate that client devices only enter room 216 via the door 218, by virtue of the fact that the location histories show all client devices passing through the door 218 before being present in the room 216. As such, it is unlikely that a client device, such as the client device 202, is within the room 216 unless it has previously passed through the door 218. As can be seen from the direction of travel of the client device 202 from point 204 to point 212, the client device 202 has not passed near the door 218, and thus positions within the room 216 can be eliminated from the estimate. These constraints may also be provided by specialized mapping devices or other methods, and may not require users to provide location histories.

User location history data provided in this manner may be done in an “opt-in” fashion, allowing users to specifically select that they wish to provide location history data for use in improving the indoor navigation system. Any user data provided in this manner is anonymized and aggregated to eliminate any personally identifying information. At point 212, the client device 202 approaches a QR code 216. The QR code 216 provides a position marker that is visible to a camera located on the client device 202. A number, string, or other data embedded within the QR code 216 may be used as a marker identifier in the same manner as described with respect to the RFID security system 214. For example, the QR code 216 may be present within a poster as hung on a wall, or on a special sticker used to establish position locations. The QR code 216 may contain an embedded numerical identifier that the client device may report to a remote server to receive the location of the QR code 216.

Descriptions related to the QR code 216 and the RFID security system 214 are not intended to be limiting and may be interchangeable with each other and with other methods of establishing a unique identifier associated with a particular location and perceivable by a client device 202. For example, the client device may use the camera to identify a particular building, sign, landmark, or other identifier to identify the particular location.

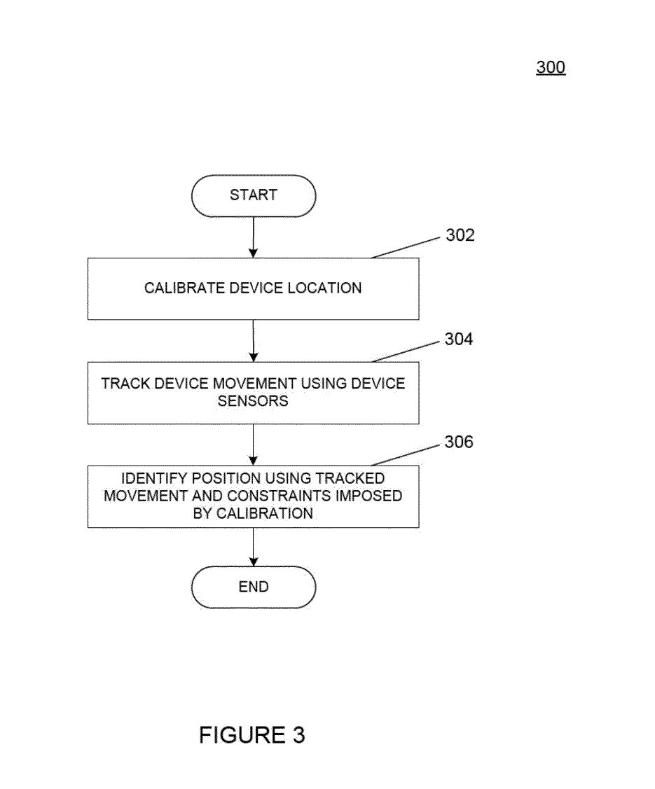

FIG. 3 is a flow diagram depicting an exemplary method 300 for identifying an indoor position using a client device, such as the client device 104, in accordance with aspects of the disclosure. In this manner, the client device may continue to provide location based services, such as route finding and location identification, despite the fact that line-of-sight for a GPS receiver may be unavailable. The method 300 leverages components that are present in common mobile devices, such as PDAs, smartphones, cellular phones, laptops, etc., to provide these location services.

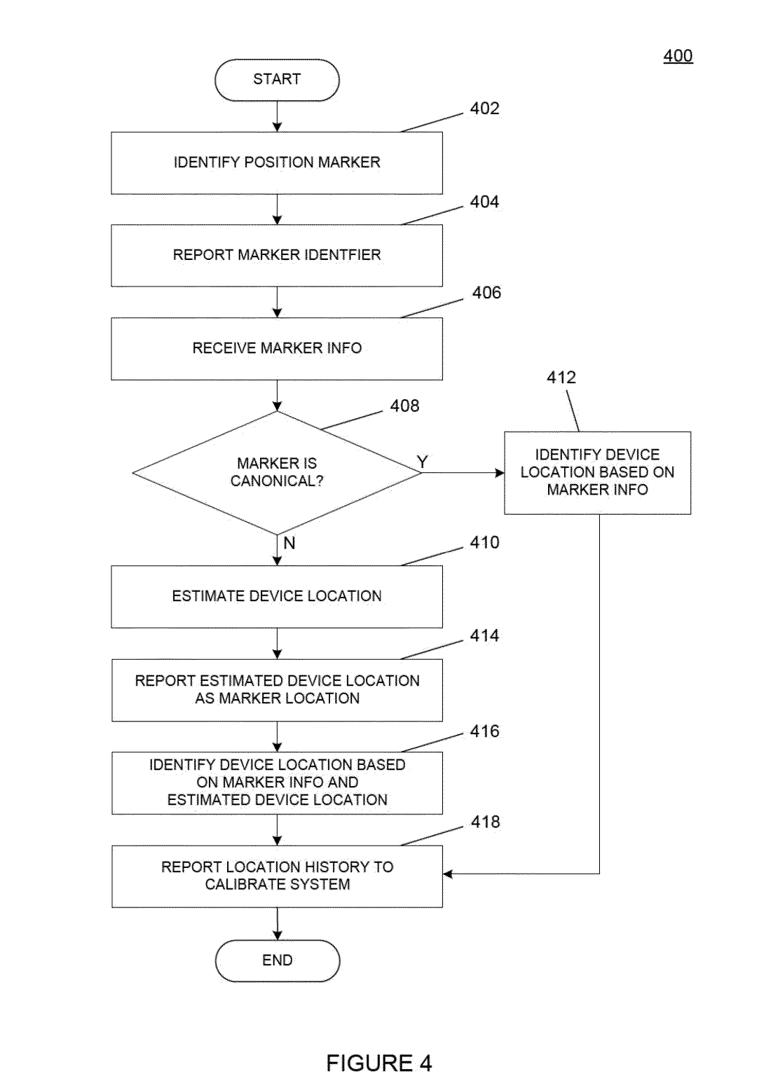

At stage 302, a location of the client device is calibrated. The location may be calibrated in a variety of manners, such as by referencing a last available GPS fix, receiving a location directly from a position marker (e.g., a QR code with the latitude and longitude encoded), or by reporting a position marker identifier and receiving the location of the position marker from a remote server. An exemplary method of calibrating a client device location is described further below (see FIG. 4). In some aspects, the calibration process also includes receiving a set of location constraints from a remote server. These location constraints may be associated with the vicinity of the client device, such as if the client device is in a particular shopping mall, office building, city block, or the like.

At stage 304, movement of the client device is tracked using an accelerometer, a gyroscope, a step counter, and/or a compass. The accelerometer, gyroscope, step counter, and compass may track the movement of the client device as a series of vectors. For example, the gyroscope may provide an orientation of the client device relative to gravity, and the accelerometer may track acceleration (and thus velocity) in a particular direction as identified by the gyroscope. The compass may provide a bearing. In some aspects, the client device may incorporate multiple accelerometers and/or gyroscopes to identify acceleration, rotation, and orientation along multiple axes. In this manner, the movement of the client device may be stored as a series of vectors.

At stage 306, the position of the client device is identified by summing the vectors identified at stage 304 with the calibrated position as determined at stage 302. In some aspects, constraints received at stage 302 may also be used to improve the accuracy of the estimated location.

FIG. 4 is a flow diagram depicting an example method 400 for calibrating a positioning module of a client device in accordance with aspects of the disclosure. The method 400 serves to identify an initial location of a client device for use in a situation where line-of-sight to GNSS satellites is unavailable. The method 400 is also capable of receiving information about the local environment in the vicinity of the client device, such as a set of location constraints as described above. The method 400 may calibrate the client device to a particular degree of accuracy depending upon the process by which the location is identified. For example, if the location is identified via a non-canonical position marker, then the method 400 may use a secondary method to further identify the device location. The method 400 may also assist with initialization and/or calibration of position marker information (e.g., the latitude and longitude of the position marker) stored on a remote server by reporting estimated position marker locations and/or location histories of the client device.

At step 402, a position marker is identified. For example, as described above, a client device may identify a QR code on a building wall. The QR code may contain an embedded identifier, such as an integer value or a series of characters. As described above, the client device may identify a position marker in a variety of manners, including receiving the identifier via a RFID transmission.

At stage 404, the marker identifier associated with the position marker is reported, such as to a remote server. The marker identifier may be transmitted within a location request to the remote server in order to provide the remote server with data sufficient to identify the position marker and supply the client device with information associated with the position marker.

At stage 406, the marker information is received by the client device. The marker information may include a position of the position marker, such as the latitude and longitude of the position marker, and position constraints for the area around the position marker, such as the location of nearby doors or stairwells. The marker information may further include identification of whether the marker is a canonical marker.

At stage 408, the method 400 branches depending upon whether the position marker is canonical. As described above, canonical markers have either been verified independently using high precision instruments or have been measured by enough estimated positions such that the remote server can have a certain degree of confidence that the location of the position marker is accurate. In some aspects, the method 400 may differentiate between position markers that have been verified by a large number of users and position markers that have been independently measured by a trusted source, such as the operator of the indoor navigation system and/or the remote server. Thus, position markers may be divided into sets containing trusted position markers (as verified by the trusted source, such as with a high-precision GPS receiver), likely position markers (as identified by a threshold number of users within a threshold degree of accuracy), and unknown position markers (all other position markers).

If the position marker is canonical, at stage 412 the device location may be identified based on the location of the marker as received at step 406. No further processing is necessary because the position marker has been independently verified as accurate. In some aspects, if the position marker is a likely marker but not verified, the client device may report the current estimated location as described below with respect to stage 414.

If the position marker is not canonical, at stage 410 the location of the client device may be estimated. The best estimate of the current device location may include verification from secondary methods (e.g., cellular triangulation, wireless access point identification, movement vector analysis, etc. as described above), and the use of location constraints as received at step 406. For example, the estimated location may indicate that the user has gone up a floor, but the constraints may indicate that the user has not traveled near a stairwell or elevator, thus indicating that the third floor estimate is erroneous.

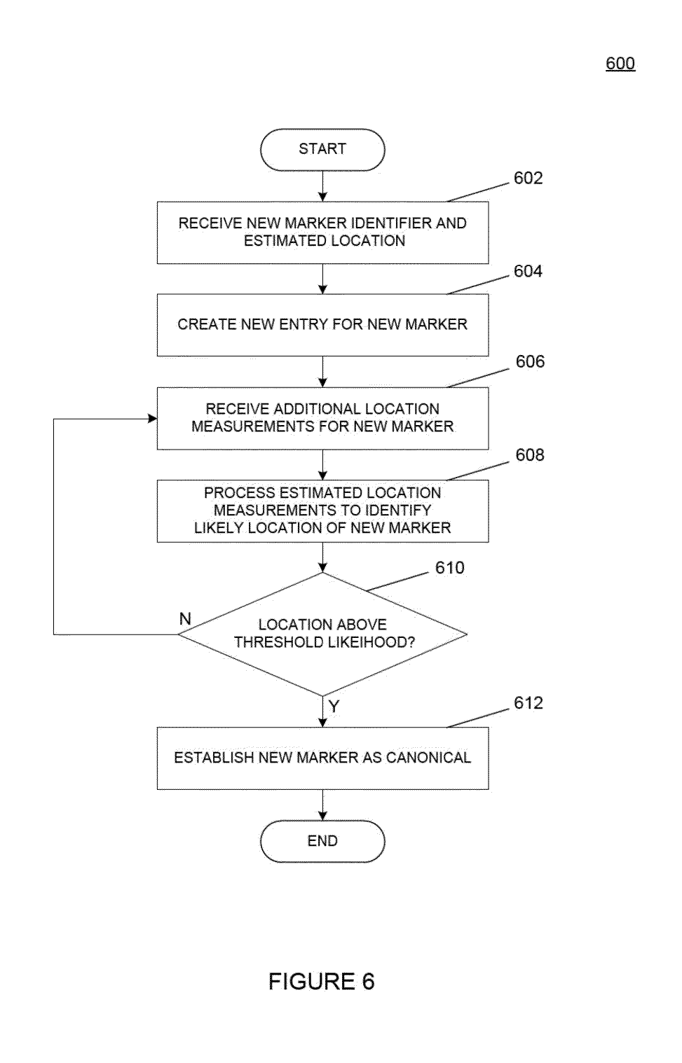

At stage 414, the estimated device location is reported as the location of the marker in order to further calibrate the position of the marker on the remote server. A method by which the remote server may update the position of the position marker is described further below (see FIG. 6).

At stage 416, the estimated location is used in concert with the location of the position marker as received within the marker information to identify the current device location. The amount of emphasis given to the estimated device location as opposed to the received position marker location may vary depending upon the degree of accuracy to which the client device can estimate its own location and the likelihood of accuracy of the location identifier. For example, in a situation where the client device cannot reliably estimate its location (e.g., the device has experienced several movement vectors since the last calibration) then the location of the position marker may be given more deference in determining the location of the client device. In a situation where the position marker is not likely to be accurate (e.g., the position marker is newly initialized and has only a few measurements based on unreliable sources), then the estimated location of the client device may be given additional weight in identifying the device location.

If the estimate from the device is unreliable, and the current estimate of the marker is unreliable, then the client device may stop trying to estimate the current location, and simply ask the user to manually provide a current location, such as by using a position on a map (e.g., touching a map to enter a location), or by using an appropriate descriptive location (e.g., “near the third floor kitchen”). In general, user-prompted locations may be included as a valid position finding system that can be used to improve the precision of an estimated location.

The estimated location may also be tracked using a Kalman filter. Using such a filter, a reverse estimation of previous locations may be performed when the client device identifies its current position as a known location. For example, when the client device verifies a known location, it may be possible to run the Kalman filter in reverse using stored sensor readings. Use of a reverse Kalman filter in this manner may improve the estimates of the client device's location prior to reaching the known location.

At stage 418, the location history of the client device may be reported to assist in calibration of the system. The location history of the client device may provide additional constraints associated with the area around the position marker. For example, the location history may allow the remote server to estimate the positions of doors, stairwells, elevators, etc.

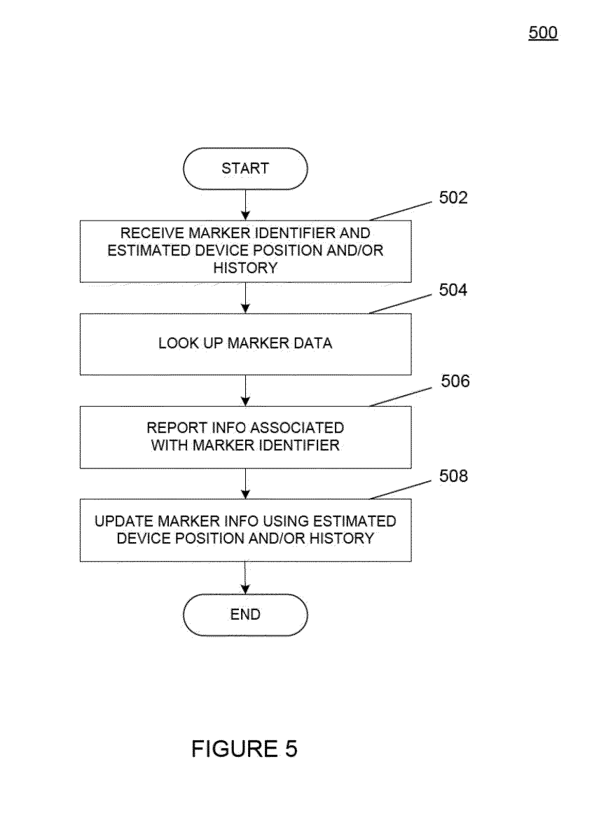

FIG. 5 is a flow diagram depicting an example of a method 500 for providing marker information in accordance with aspects of the disclosure. The remote server receives a marker identifier from the client device, and accesses a set of data associated with the marker identifier, which may include the location of the position marker associated with the marker identifier, whether the position marker is a canonical marker, and environmental constraints describing the environment around the position marker. In this manner the client device may be informed of its location and the surrounding environment without requiring line-of-sight to GNSS satellites.

At stage 502, a marker identifier and an estimated location and/or location history are received. The marker identifier notifies the server of which marker information to send to the client device. The estimated location and the location history may be used by the server to update/verify the location of the position marker and/or determine environmental constraints around the identified position marker.

At stage 504, the information associated with the marker identifier is looked up in the marker data, such as the marker data 116 described above with respect to FIG. 1. This information may include the location of the position marker, whether the position marker is canonical, environmental constraints describing the area around the position marker, and any other data associated with the identified position marker that may be relevant to determining a position of the client device.

At stage 506, the information as determined at step 504 is reported to the client device, such as via the network 136 described with respect to FIG. 1.

At stage 508, the information associated with the marker identifier is updated with the estimated device position and/or location history as received at stage 502. For example, the estimated device location may be used to further refine the location of the position marker, or the location history may be used to identify additional environmental constraints on the position of the client device. For example, the remote server may employ a global constraint solver to determine the location of position markers, walls, and other internal features using the location history.

FIG. 6 is a flow diagram depicting an example method 600 for employing an adaptive positioning system in accordance with aspects of the disclosure. The adaptive positioning system learns the location of position markers by receiving estimated client device locations along with identifiers describing the position markers located nearby. In this manner the method 600 can integrate new position markers into the system without the need for the operator of the system to independently verify the location of the position marker. As such, new position markers can be placed by users, which are then reported and verified by other users for accuracy. The system may employ a Kalman filter to accurately identify the location of a position marker using one or more estimated locations. The system may also identify the position marker as canonical once the location has been verified above a threshold degree of accuracy. For example, a user may print out a flyer or poster using their home computer, where an application automatically embeds a new identifier within the flyer, such as a QR code. The user may then place the flyer in an indoor location to serve as a position marker for indoor navigation.

At stage 602, a new marker identifier and a location for the new position marker are received. The location may be an estimated location, such as a location determined using a series of movement vectors after an initial calibration derived from a canonical marker.

At stage 604, a new entry is created for the new position marker within the marker data 116. The new entry may initialize the position marker with the marker identifier and the estimated location and any constraints associated with the area around the estimated location.

At stage 606, additional location measurements are received for the new position marker. For example, other client devices may access the new position marker to attempt to receive a position fix, and provide their estimated locations. These additional measurements are included in the marker information and used to refine the location of the position marker.

At stage 608, the estimated location measurements received for the position marker are processed to determine a more accurate location for the position marker. A single position measurement may not provide sufficient accuracy to reliably indicate the location of a position marker. For example, if the user places their flyer in a position up several flights of stairs and down several hallways, an estimated position that relies on the accelerometers, gyroscopes, and/or a compass within a client device may not be accurate due to the large number of movement vectors and the fact that such data tends to be noisy. However, as more and more estimated measurements are received the system is able to determine the location with increasing accuracy. For example, the system may employ a Map-Reduce operation, where all position requests for a particular position marker are identified, sorted by time and filtered, such as via a Kalman filter or other temporal filter (e.g., an exponential box filter) to produce an updated location estimate.

At stage 610, the updated location estimate is identified as being above a certain likelihood of accuracy. For example, the threshold may identify a particular number of measurements reported for the position marker or that a certain number of measurements must be within a threshold distance of a particular point. A combination of these thresholds or some other method of identifying the likelihood of accuracy may also be employed. If the updated location estimate exceeds the specified accuracy threshold, then the position marker is identified as a canonical position marker at stage 612. Otherwise the method returns to stage 606 to await further measurements.

Although stage 612 is described as establishing a position marker as canonical, the position marker may be assigned a particular accuracy value rather than merely “canonical,” or “not canonical.” This accuracy value may determine how the location information is processed by the client device, and whether the client device relies on secondary methods to verify the location or increase the accuracy of the device's estimated location.

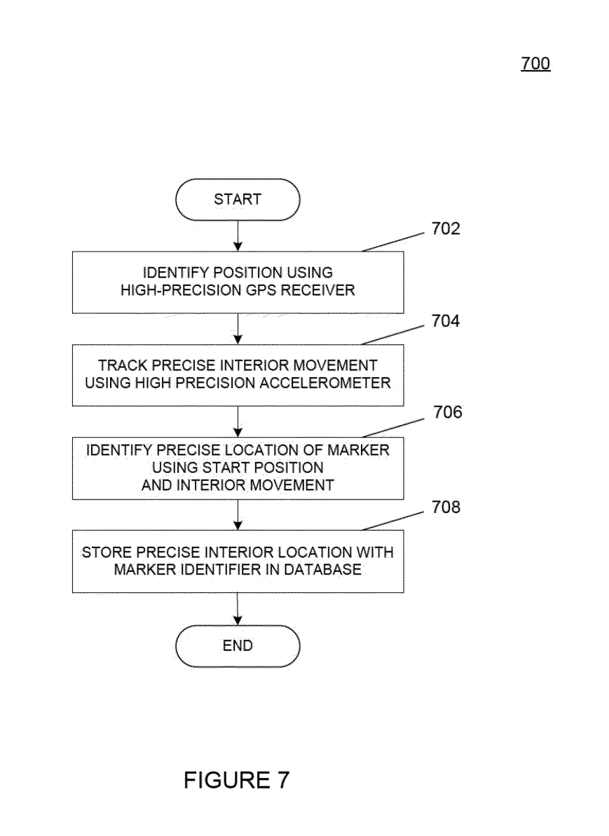

FIG. 7 is a flow diagram depicting an example method 700 for initializing a position marker using a precise position fix in accordance with aspects of the disclosure. Aspects of the method 700 rely on the use of high-precision devices such as GPS receivers or accelerometers to establish an accurate position of one or more position markers. New position markers may be initialized using a precise position fix to “seed” the positioning system with position markers at known locations. These position markers may act as a base to establish positions of other position markers, such as by the method 600 described above (see FIG. 6).

At stage 702, an initial position is identified using a high-precision device, such as a high-precision GPS receiver. This initial position may be identified at an entrance to an indoor location, such as at the last point prior to losing an accurate GPS fix due to a loss of line-of-sight.

At stage 704, high precision accelerometers track movement of the high-precision device as it enters the indoor location and proceeds to the location of the position marker. For example, if the position marker is in a hallway of the building and on the second floor, the high-precision device tracks the vectors needed to reach the position marker as a vector from the initial position established by the GPS receiver. Aspects of the method 700 may also rely on various other methods of identifying a precise location. For example, laser sighting from known position location into entrance ways or through windows may be used to determine a precise location of various indoor locations. Photogrammetry based mechanisms may also be used to compute accurate positions of internal features. These internal features may be labeled with RFID or QR tags for use in location determination operations as described above. Building blueprints may also be used to identify precise locations of particular features (e.g., particular door locations).

At stage 706, the movement vector is added to the initial position to determine the location of the position marker. For example, the path down the hallway and up a set of stairs to the second floor is converted to a vector and then added to the initial position to establish a high-precision location for the position marker.

At stage 708, the position identified at stage 706 is uploaded to the remote server and stored in a set of marker data. The position may be identified as canonical within the database, as the position has been independently verified by the operator of the system. Some aspects of the system may omit the accelerometer positioning element, such as where the position marker is in a location that provides a clear line-of-sight to GNSS satellites. In this manner a canonical position marker can be established without the need to navigate indoors.

The stages of the illustrated methods described above are not intended to be limiting. The functionality of the methods may exist in a fewer or greater number of stages than what is shown and, even with the depicted methods, the particular order of events may be different from what is shown in the figures and include additional stages or omit stages as shown.

The systems and methods described above advantageously provide indoor navigation and location identification services. By leveraging features commonly available in mobile devices, such as accelerometers, gyroscopes, and cameras, aspects of the method and system provide location information in environments where traditional methods are sub-optimal, such as indoors. The system includes an adaptive model that allows simple integration of new position markers and location constraints as provided in an opt-in manner by users. Data may be maintained in an anonymous and encrypted manner to safeguard user information, and aspects of the systems and method allow for the use of such technology without the need to link a particular user to a particular location.

As these and other variations and combinations of the features discussed above can be utilized without departing from the disclosure as defined by the claims, the foregoing description of the embodiments should be taken by way of illustration rather than by way of limitation of the disclosure as defined by the claims. It will also be understood that the provision of examples of the disclosure (as well as clauses phrased as “such as,” “e.g.”, “including” and the like) should not be interpreted as limiting the disclosure to the specific examples; rather, the examples are intended to illustrate only some of many possible embodiments.

1. A computer-implemented method for providing indoor navigation services, the method comprising:
estimating, using one or more processors, a position of a client device using a summation of detected movement of the client device;
identifying a fixed position marker using the client device, wherein the fixed position marker comprises a marker identifier that uniquely identifies the position marker from a plurality of position markers;
receiving at the one or more processors a set of marker information associated with the marker identifier, wherein the set of fixed marker information comprises a marker location of the position marker and environmental constraints for an area around the position marker; and
updating, using the one or more processors, the estimated position of the client device using the marker location and the environmental constraints.

2. The method of claim 1, wherein the fixed position marker is a quick response code or a radio frequency identifier tag identified by the client device.

3. (canceled)

4. The method of claim 1, further comprising using the environmental constraints to improve the accuracy of the location client device.

5. The method of claim 1, further comprising:
identifying a movement vector of the client device to track client device movement from the position marker using on-board sensors of the client device; and
determining a new location of the client device using the movement vector and the marker location.

6. The method of claim 5, wherein the on-board sensors are at least one of an accelerometer, a step counter, and a gyroscope.

7. The method of claim 5, further comprising improving the measured movement vector using data from at least one of a compass and a gyroscope.

8. The method of claim 1, further comprising sending a location request to a remote server, wherein the location request includes the marker identifier.

9. The method of claim 8, wherein the location request further comprises the estimated location of the client device such that the remote server may update the marker information with the estimated location of the client device.

10. The method of claim 1, further comprising extracting the set of marker information from data embedded within the position marker.

11. The method of claim 1, further comprising:
determining whether the position marker is a canonical position marker from the set of marker information; and
if the position marker is not a canonical position marker, using a secondary method of identifying the second location of the client device in response to the determination that the position marker is not a canonical position marker.

12. The method of claim 11, wherein the secondary method is at least one of cellular tower triangulation, global positioning system identification, or wireless access point identification.

13. A system for providing indoor navigation services, comprising:
a position marker database storing marker information in association with marker identifiers for a plurality of fixed position markers, wherein for each fixed position marker, the marker information comprises a marker location of the fixed position marker and environmental constraints for an area around the position marker; and
at least one processor, coupled to the memory, the at least one processor operable to:
receive, from a client device, an estimated position of the client device, the estimated position being based on a summation of detected movement of the client device;
receive, from the client device, the marker identifier associated with a particular position marker;
access the marker information associated with the marker identifier;
transmit the marker location and the environmental constraints to the client device for use in updating the estimated location of the client device.

14. The system of claim 13, wherein the at least one processor is further configured to update the marker information in the position marker database with the estimated location to improve the accuracy of the location of the particular position marker.

15. The system of claim 14, wherein the at least one processor is further configured to establish a new entry in the position marker database for a new position marker based on a location of the new position marker as identified by the client device.

16. The system of claim 14, wherein the at least one processor is further configured to identify the particular position marker as canonical when the location of the particular position marker is established with greater than a particular accuracy threshold.

17. The system of claim 16, wherein the particular accuracy threshold is a minimum number of measurements received.

18. A computer-implemented method for providing indoor navigation services, the method comprising:
receiving, from a client device, an estimated client device location;
receiving, from the client device, a location request comprising a marker identifier;
accessing, using one or more processors, a set of marker data that comprises a marker location of one or more fixed position markers and environmental constraints for an area around the fixed position marker, wherein each of the fixed position markers is indexed within the set of marker data by a unique identifier;
determining, using the one or more processors a location of a fixed position marker associated with the marker identifier, wherein the determining comprises matching the marker identifier with the unique identifier;
determining, using the one or more processors, the location of the client device using the marker location and the environmental constraints; and
updating the set of marker data using the determined client device location.

19. (canceled)

20. The method of claim 18, further comprising:
including the client device location in a portion of the set of marker data describing the position marker associated with the marker identifier; and
using the client device location to improve the accuracy of the location of the position marker associated with the marker identifier.

21. The method of claim 18, further comprising:
receiving an uninitialized marker identifier and an initial location estimate;
including the uninitialized marker identifier in the set of marker data as a new position marker; and
associating the initial location estimate with the new position maker.

22. The method of claim 21, further comprising:
receiving an additional location estimate for the new position marker;
including the additional location estimate in the set of marker data; and
determining a location of the new position marker using the additional location estimate and the initial location estimate.

23. The method of claim 22, further comprising:
determining an estimated accuracy of the location of the new position marker based on at least one of a number of location estimates received for the new position maker and the location of a plurality of location estimates received for the new position marker; and
identifying the new position marker as a canonical position marker when the estimated accuracy exceeds a particular threshold value.

24. A non-transitory computer readable storage medium containing instructions that, when executed by a processor, perform a method comprising:
estimating a position of a client device using a summation of detected movement of the client device;
identifying a fixed position marker using a client device, wherein the fixed position marker comprises an identifier that uniquely identifies the position marker from a plurality of position markers;
receiving a set of marker information associated with the identifier, wherein the set of marker information comprises a marker location of the fixed position marker and environmental constraints for an area around the position marker; and
updating the estimated position of the client device using the marker location and the environmental constraints.

25. The storage medium of claim 24, wherein the position marker is a quick response code or a radio frequency identifier tag identified by the client device.

26. (canceled)

27. The storage medium of claim 24, further comprising using the set of environmental constraints to improve the accuracy of the client device location.

28. The storage medium of claim 24, further comprising:
identifying a movement vector of the client device to track client device movement from the position marker using at least one accelerometer to measure a velocity and a direction of travel; and
determining a new location of the client device using the movement vector and the marker location.
